(19) United States
(12) Patent Application Publication
(10) Pub. No.: US 2015/0186891 A1
(43) Pub. Date: Jul. 2, 2015

(54) LOCATION OBFUSCATION FOR AUTHENTICATION

(71) Applicants: Kim Wagner, Sunnyvale, CA (US); John Sheets, San Francisco, CA (US)

(72) Inventors: Kim Wagner, Sunnyvale, CA (US); John Sheets, San Francisco, CA (US)

(21) Appl. No.: 14/585,770

(22) Filed: Dec. 30, 2014

Related U.S. Application Data
(60) Provisional application No. 61/923,153, filed on Jan. 2, 2014.

(51) Int. Cl. G06Q 20/40

(52) U.S. Cl. CPC G06Q 20/4016

(57) ABSTRACT

Methods, system, and apparatuses are presented for performing location-based fraud detection (e.g., in e-commerce transactions) while alleviating privacy concerns. Location-based fraud detection may utilize an intermediary (i.e., third party server), which collects the actual location of mobile phones and then obfuscates the collected location information. Obfuscation of location information may comprise assigning region identifiers to geographical regions, where a region identifier can be associated with a transaction that was conducted in a corresponding geographical region. Overlapping regions of varying resolutions may be utilized, each region size corresponding to a set of regions. The intermediary may provide obfuscated location information to an entity (i.e., fraud detection system) that performs the location-based fraud detection based on the obfuscated location information. The entity may aggregate statistical values based on received obfuscated location information of a user's historical transactions and utilize the values when performing the location-based fraud detection.

### CROSS-REFERENCES TO RELATED APPLICATIONS

The present application claims priority from and is a non-provisional application of U.S. Provisional Application No. 61/923,153, entitled “Location Obfuscation for Authentication” filed Jan. 2, 2014, the entire contents of which are herein incorporated by reference for all purposes.

### BACKGROUND

Location-based services are well known, but have privacy implications. Some users would not want to allow their mobile phone location to be recorded by another entity. Others would opt out of a service utilizing their location information when given the choice. However, this would make it difficult for such users to obtain benefits of location-based services. An example of a useful location-based service is location-based risk analysis.

Location-based risk analysis can be utilized to detect fraudulent transactions. For example, a payment or wallet application may utilize location information of a user's mobile phone to carry out risk analyses of the user's transactions. Yet, users may be wary to allow their location information to be utilized and may opt out of location-based risk analysis and miss out on such beneficial protection. Accordingly, there is a need for a method that can provide some of the same benefits of location-based services, e.g., location-based fraud protection, while alleviating consumer privacy concerns.

Embodiments of the present invention address these problems and other problems individually and collectively.

### SUMMARY

Methods, system, and apparatuses are presented for performing location-based fraud detection (e.g., in e-commerce transactions) while alleviating privacy concerns. In some embodiments, the services providing location-based fraud detection may utilize an intermediary (i.e., third party server), which collects the actual location of mobile phones and then obfuscates the collected location information. The intermediary may provide obfuscated location information to an entity (i.e., fraud detection system) that performs the location-based fraud detection based on the obfuscated location information. An example intermediary may include any telecommunications company that routinely collects data about mobile devices. In some embodiments, the obfuscation of the data can be done in such a way that (1) actual location information cannot be feasibly derived, and/or (2) much of the same pattern match checking can still be done, as if the data revealed were actual locations, in order to correlate patterns of spending with patterns of location.

According to some embodiments, a fraud detection system receives transaction data for a first transaction by a first user, the transaction data including a first time of the first transaction. The fraud detection system can further receive, from a third party server, a first region identifier that corresponds to a first geographical region in which the first transaction occurred at the first time. The third party server can be configured to store a mapping of geographical coordinates to region identifiers of geographical regions, each geographical region having an assigned region identifier; determine first geographical coordinates of the first user at the first time based on a location of a mobile device of the first user; and select the first region identifier from the region identifiers using the first geographical coordinates, where the first region identifier obfuscates the first geographical coordinates from the fraud detection system.

The fraud detection system can access historical transaction information of the first user from a database. The historical transaction information may include one or more statistical values associated with each of a plurality of the region identifiers of geographical regions, where each of the statistical values convey an amount of transactions by the first user within a specified time period for the geographical region corresponding to the region identifier associated with the statistical value. The fraud detection system can identify the one or more statistical values associated with the first region identifier received from the third party server and calculate a classification of fraud for the first transaction based on the one or more identified statistical values corresponding to the first region identifier.

Embodiments can periodically refresh (e.g., by randomizing) region identifiers assigners to geographic regions or use such random. Information stored in the third party server and the fraud detection system can be updated accordingly.

Some embodiments can determine to not authorize the first transaction if the classification of fraud for the first transaction exceeds a certain threshold. In addition or instead, embodiments can send an alert if the classification of fraud for the first transaction exceeds a certain threshold.

Regions of varying resolution associated with regions identifiers can be used in the obfuscation of the location information. For example, risk analysis (fraud detection) may be carried out on multiple sets of regions, each corresponding to a different size. Each result of risk analysis corresponding to a set of regions may contribute to an overall classification of fraud. The multi-resolution regions may overlap with each other.

Embodiments of the present invention provide some of the same benefits as location based risk scoring, without divulging the actual whereabouts of the mobile phone or other electronic device utilized to conduct a purchase transaction.

Other embodiments are directed to systems and computer readable media associated with methods described herein.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an exemplary system diagram, according to some embodiments of the invention.

FIG. 2 is an exemplary mapping of geographical regions to region identifiers, according to some embodiments of the invention.

FIG. 3 is an exemplary image of a geographic region whose location may be obfuscated by use of concentric multi-resolution regions, according to some embodiments of the invention.

FIG. 4 is an exemplary location obfuscated by lining the boundary of one set of regions with another set of regions, according to some embodiments of the invention.

FIG. 5 is an exemplary process flow, according to some embodiments of the invention.

FIG. 6 is exemplary statistical information that may be utilized by the fraud detection system, according to embodiments of the invention.

FIG. 7 is an example computer system according to some embodiments.

The word “exemplary” is used herein to mean “serving as an example, instance, or illustration.” Any embodiment or design described herein as “exemplary” is not necessarily to be construed as preferred or advantageous over other embodiments or designs.

### DETAILED DESCRIPTION

Embodiments can provide users with benefits of location-based risk analysis, while maintaining privacy of their location information. A fraud detection system can conduct a risk analysis of a particular transaction based on the user's historical transactions, using obfuscated location information that does not identify geographical coordinates of the user. A third party server can obfuscate the location information by assigning region identifiers to geographical regions, where the fraud detection system does not know a correspondence between region identifiers and geographical regions. The region identifiers can be assigned randomly to the geographical regions, and the assignments can be updated periodically.

Each of the user's transactions can be associated with a region identifier corresponding to the geographical region in which the transaction occurred. One or more statistical values (e.g., based on a frequency of historical transactions corresponding to a region identifier) can be calculated and utilized for a risk analysis of a particular transaction. Various embodiments may comprise sets of regions that have varying resolution and that may overlap with each other. For a particular transaction, a separate risk analysis may be conducted using each set of regions, and a result of each risk analysis may contribute to an overall classification of fraud.

Components that may be utilized in certain embodiments are described in more detail below.

### I. System

An example system including a third party server and a fraud detection system is described, as well as examples of the collection and storage of consumer location data.

A. Example Architecture

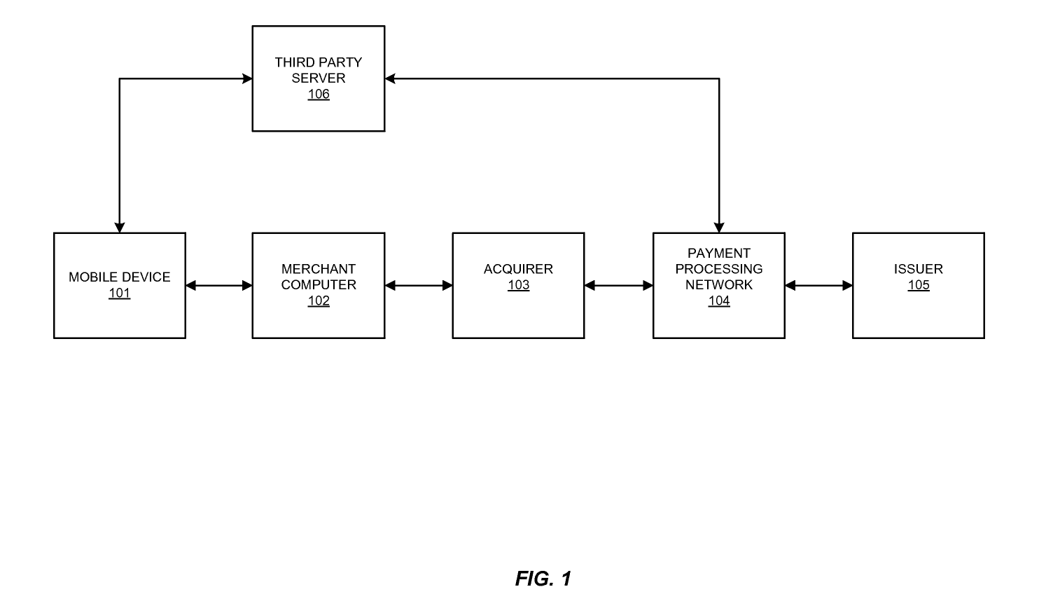

FIG. 1 is an exemplary system diagram, according to some embodiments of the invention. A user may utilize mobile device 101 to conduct payment transactions in communication with a merchant computer 102. As used herein, a “mobile device” may include a mobile phone, tablet, netbook, laptop, or any other suitable mobile computing device. Merchant computer 102 may be connected to acquirer computer 103. Acquirer computer 103 may be connected to issuer computer 105 via payment processing network 104. Third party server 106 may be in communication with mobile device 101 and payment processing network 104 by any suitable communication network.

As used herein, an “issuer” may typically refer to a business entity (e.g., a bank) that maintains financial accounts for a user and often issues a mobile device 101 such as a credit or debit card to the user. A “merchant” is typically an entity that engages in transactions and can sell goods or services. An “acquirer” is typically a business entity (e.g., a commercial bank) that has a business relationship with a particular merchant or other entity. Some entities can perform both issuer and acquirer functions. Some embodiments may encompass such single entity issuer-acquirers. Each of the entities may comprise one or more computer apparatuses (e.g., merchant computer 102, acquirer computer 103, payment processing network 104, and issuer computer 105) to enable communications or to perform one or more of the functions described herein.

The payment processing network 104 may include data processing subsystems, networks, and operations used to support and deliver certificate authority services, authorization services, exception file services, transaction scoring services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 104 may include one or more server computers. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 104 may use any suitable wired or wireless network, including the Internet.

In embodiments of the invention, payment processing network 104 may comprise a fraud detection system that may carry out risk analysis based on obfuscated location information received from third party server 106. Payment processing network 104 may store, in its server computer, historical transaction data and corresponding statistical values calculated based on obfuscated location information.

In some payment transactions, the user purchases a good or service at merchant computer 102 using a mobile device 101. The user's mobile device 101 can interact with an access device at a merchant associated with merchant computer 102. The access device 106 may be any suitable device that may comprise the capability to accept a transaction made by a payment device. For example, the user may tap the mobile device 101 against an NFC reader in the access device. When the mobile device 101 interacts with the access device or merchant computer 102, the access device or merchant computer 102 may communicate with a mobile application. Alternatively, the user may indicate payment details to the merchant electronically, such as in an online transaction.

An authorization request message may be generated by mobile device 101 or merchant computer 102 and then forwarded to the acquirer computer 103. After receiving the authorization request message, the authorization request message is then sent to the payment processing network 104. The payment processing network 104 then forwards the authorization request message to the corresponding issuer computer 105 associated with an issuer associated with the user.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction (e.g., the transaction amount), merchant identifier, merchant location, etc., as well as any other information that may be utilized in determining whether to identify and/or authorize a transaction. The authorization request message may also include other information, such as information that identifies the access device that generated the authorization request message, information about the location of the access device, etc.

After the issuer computer 105 receives the authorization request message, the issuer computer 105 sends an authorization response message back to the payment processing network 104 to indicate whether the current transaction is authorized (or not authorized). The payment processing network 104 then forwards the authorization response message back to the acquirer 103. In some embodiments, payment processing network 104 may decline the transaction even if issuer computer 105 has authorized the transaction, for example, depending on a value of a fraud risk score or other classification of fraud. The acquirer 103 then sends the response message back to the merchant computer 102.

An “authorization response message” may be an electronic message reply to an authorization request message generated by an issuing financial institution 105 or a payment processing network 104. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network 104) to the merchant computer 102 that indicates approval of the transaction. The code may serve as proof of authorization. As noted above, in some embodiments, a payment processing network 104 may generate or forward the authorization response message to the merchant.

After the merchant computer 102 receives the authorization response message, the merchant computer 102 may then provide the authorization response message for the user. The response message may be displayed by the mobile device 101, or may be printed out on a physical receipt. Alternately, if the transaction is an online transaction, the merchant may provide a web page or other indication of the authorization response message as a virtual receipt. The receipts may include transaction data for the transaction.

At the end of the day, a normal clearing and settlement process can be conducted by the payment processing network 104. A clearing process is a process of exchanging financial details between an acquirer and an issuer to facilitate posting to a customer's payment account and reconciliation of the user's settlement position.

Third party server 106 may be an intermediary capable of collecting actual location information associated with mobile device 101. An example of a third party would be a telecommunications company, which has access to location data of a user's mobile device. Further, third party server 106 may have the capability to obfuscate location information by assigning region identifiers to geographic coordinates within certain regions. Third party server 106 may store this mapping and also have the capability to randomize (or otherwise refresh) the assignments of region identifiers periodically. Third party server 106 may send obfuscated location information to payment processing network 104, which may utilize the information for location-based risk analysis. The risk analysis may determine whether the transaction will get authorized. Payment processing network 104 can correlate transactions with particular obfuscated regions and create statistical values (e.g., an amount of transactions per unit time) of historical transaction information.

A communication network may include any suitable network entities and devices that can enable connectivity amongst various entities. In some embodiments, the communication network may enable wireless communication that may allow the exchange of information between entities, such as mobile device 101, merchant 102, acquirer 103, and payment processing network 104. In some embodiments, a communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

The server computer may be coupled to a database (e.g., which stores historical transaction information) and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

B. Collection and Storage of Consumer Location Data

A third party server (i.e., an intermediary) may capture actual location information associated with a user's mobile device. The collection of location data may be carried out in various ways. For example, the third party server may gather location information from a mobile device in regular intervals or near the time of a transaction. A fraud detection system (i.e., a risk assessor) may request information associated with the collected location information from the third party server.

In some embodiments, the third party server may collect location data from a mobile device when the user associated with the mobile device makes a transaction. Thus, a transaction may act as a trigger event for the payment processing network to request to the third party server to query the mobile device associated with the transaction for location information. The third party server may retrieve the location information at the time of the transaction. In some implementations, this information may be processed in real-time and utilized for location-based risk analysis of the transaction at the time of purchase. In other implementations, this information may be stored for later use by the fraud detection system during the settlement process of the transaction.

In other embodiments, the third party server may collect location data from a mobile device in regular intervals and later retrieve location information corresponding to a certain time period. For example, the third party server may query the location of a user's mobile device every five minutes and store retrieved location information. The fraud detection system may request location information of the user's mobile device at a particular time corresponding to the time the user carried out a transaction. The third party server can then retrieve location data collected at the time closest to the timestamp of the transaction specified by the fraud detection system. In some implementations, the third party server may retrieve more than one location data point in response to a query by the fraud detection system. For example, the third party server may take the two locations collected at the start and end of the five minute time interval that the transaction time falls in and take the middle of the two locations. Any suitable algorithm may be utilized to extrapolate an estimated location associated with a specific timestamp given multiple locations collected over time intervals.

In yet other embodiments, the fraud detection system may request the information from the third party server at the end of the day or other scheduled time. In the various embodiments, the request indicates the time of the transaction for which a region identifier is desired. The request can include the time explicitly (e.g., 3:05 PM) or implicitly by requesting a location for the current time, where the request is simply for a current location.

Collecting data in intervals may provide certain advantages. Collecting data in intervals can allow the third party server to store less information than if it were to continuously retrieve location information, while still allowing for enough accuracy to estimate the actual location. Further, retrieving location data from information stored within the third party's systems allows for a quicker response time compared to the third party querying the mobile device directly for past location data each time the fraud detection system requests location information.

While the third party server may be capable of collecting actual location information of a mobile device, the third party server may not necessarily correlate a location with a specific transaction occurred. Instead, the third party server may associate locations with times that they were collected. The fraud detection system (which may be or be part of the payment processing network) can know the transaction times and correlate the transaction times with obfuscated locations. Thus, the fraud detection system can know that a transaction occurred in a region associated with a region identifier, where the region identifier obfuscates the actual location.

In various embodiments, the location data captured by the third party server may include various ones of:

(A) a mobile phone P, possibly identified by phone number, IMEI number, or account number, or another unique identifier,
(B) a point in time T (with a given accuracy, e.g. seconds),
(C) a geo-location point L (longitude, latitude), and
(D) a specified measurement accuracy (e.g., a radius R) so that it can be deduced that the mobile phone P at time T was no more than the distance R away from the point L. This location data can then be used to provide obfuscated location information to a fraud detection system.

### II. Obfuscation of Transaction Locations

Location obfuscation may comprise altering location data so that actual geographical locations cannot be derived from the obfuscated location information. An exemplary way that location information can be obfuscated includes replacing geographical data with region identifiers.

The third party server (e.g., intermediary) can obfuscate location data it has collected before sending any information to the fraud detection system (e.g., payment processing network). The fraud detection system may query the third party server for location information of a user's mobile device after recognizing that the user has conducted a transaction. Subsequently, the third party server may obfuscate location information to be sent to the fraud detection system by applying a mapping of actual geographic locations to regions identifiers. If desired, optional techniques may be applied in order to move the actual location L a random distance and direction within specified limits by indicating a larger uncertainty (increasing R), or both, before the mapping to a region identifier is applied.

A. Mapping of Geographic Coordinates to Region Identifiers

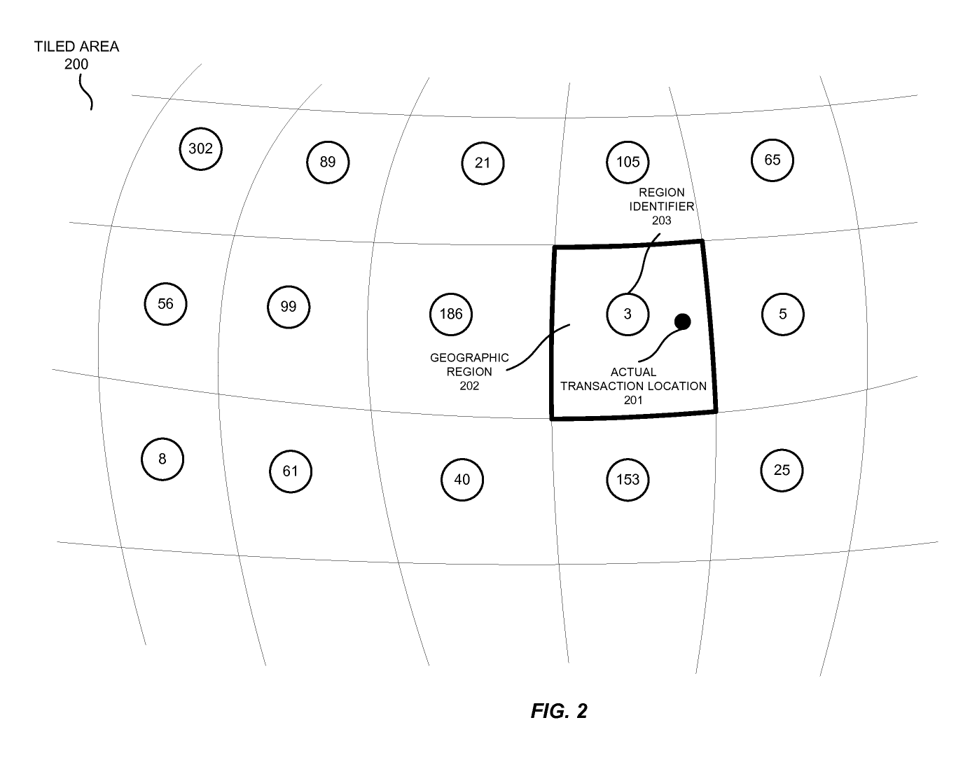

FIG. 2 is an exemplary mapping of geographical regions to region identifiers, according to some embodiments of the invention. FIG. 2 includes tiled area 200, actual transaction location 201, geographic region 202, and region identifier 203. Although the regions are displayed as disjoint tiles, the regions can have any shape and may overlap.

Tiled area 200 comprises an area split into multiple regions, each associated with a region identifier. As shown in the example of FIG. 2, a geographic area may be divided into disjoint tiles of certain size, such as geographic region 202. Each tile may be associated with a region identifier. For example, geographic region 202 may be associated with region identifier 203, which is equal to “3” in this case. While FIG. 2 shows an example of regions of similar size tile, embodiments are not so limited and may have various sizes.

The regions in tiled area 200 are numbered randomly with region identifiers (e.g., numbers from 1 to N) that do not reveal geographic locations, i.e., without a mapping stored by the third party server. The third party server does not disclose which region identifiers correspond to which regions or how the regions partition the tile area 200. Hence, when the fraud detection system requests location information associated with a transaction time that corresponds to actual transaction location 201, the intermediary server sends region identifier 203 instead of geographical coordinates of actual transaction location 201. Given region identifiers, the fraud detection system would know if two location measurements occurred within the same region, but not where those regions were geographically or where the boundaries of the regions were. For example, the fraud detection system may know that the transaction occurred in region “3”, and may also know there were seven other transactions in same region during the past month (or other time period). However, the fraud detection system would not know where region “3” is.

An area may be divided into regions of any shape or size. For example, an area may be divided into regions of one or more of tiles, squares, triangles, rectangles, circles, or any other suitable shape. The shapes may be disjoint or overlapping and of various or similar sizes. In some embodiments, the regions cover a whole area with regions assigned to region identifiers.

Region identifiers may comprise any suitable unique identifiers that do not reveal associated geographical locations. For example, region identifiers may be numerical, alphanumerical, or a combination of both. In some embodiments, the total number of region identifiers may be greater than the total number of regions. For example, an area may be partitioned into fifty regions, each of which may be randomly assigned to a number between one and one hundred.

To prevent a large collection of measurements from gradually revealing the actual location of any tiles, the assignment of region identifiers to regions may be periodically refreshed, which may be done randomly. For example, time may be partitioned into windows (e.g. one month, or one week, or one year etc.) and the assignment of numbers to regions may be carried out again by random at the start of each window. A reason for remapping region identifiers to regions can be to limit the duration that recurring patterns may occur in similar tiles, which may potentially allow information about the actual location of the user to implicitly be determined. Further, the mapping of geographical regions to region identifiers may be unique to each mobile device to prevent information from being aggregated across customers and potentially reveal actual location information. Thus, the third party server can store a separate mapping for each of a plurality of mobile devices.

For example, a user may have the locations of his purchases counted between January through March of a year. There may have been 131 transactions that occurred in Tile 57 during that time, which for January through March, refers to a 400 square mile region. To prevent the risk assessor or other entity from utilizing this information with enough other data and eventually determining where Tile 57 is located (and hence, where the user is conducting most transactions), from April to June of the same year, Tile 57 may be renumbered, e.g., to Tile 256. To enable accurate risk scoring, certain information about the user's transaction in previous Tile 57 (now 256) can be carried forward to Tile 256. For example, the risk assessor may be told that the user conducted purchases in Tile 256 “very frequently,” corresponding to the 131 transactions made in that tile during January through March. In this way, the numbering of the tiles may be continually scrambled periodically, while a measure of the relevant transaction history can still be utilized for risk assessment purposes.

In other embodiments, the fraud detection system can be informed by the third party server that a region identifier number for a particular region has changed to a different value. Any statistical values associated with the previous value can now be associated with the new value. In this manner, the fraud detection system can still track historical data for the particular region, but the relationship of the new value relative to other region identifiers would change, thereby making it more difficult to determine the actual location.

B. Utilization of Multi-Resolution Regions

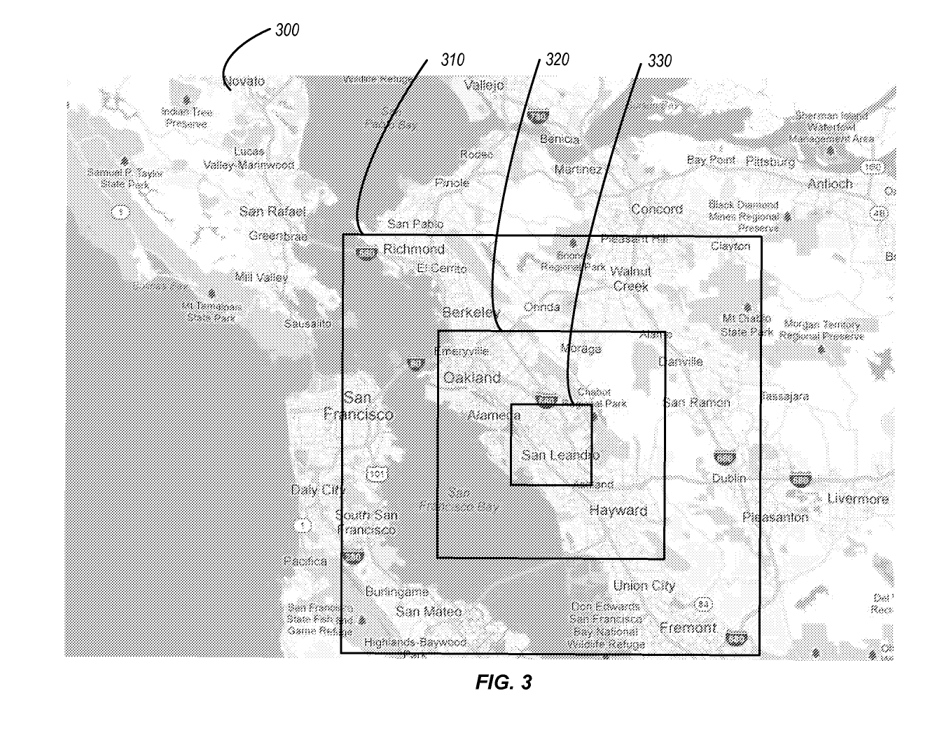

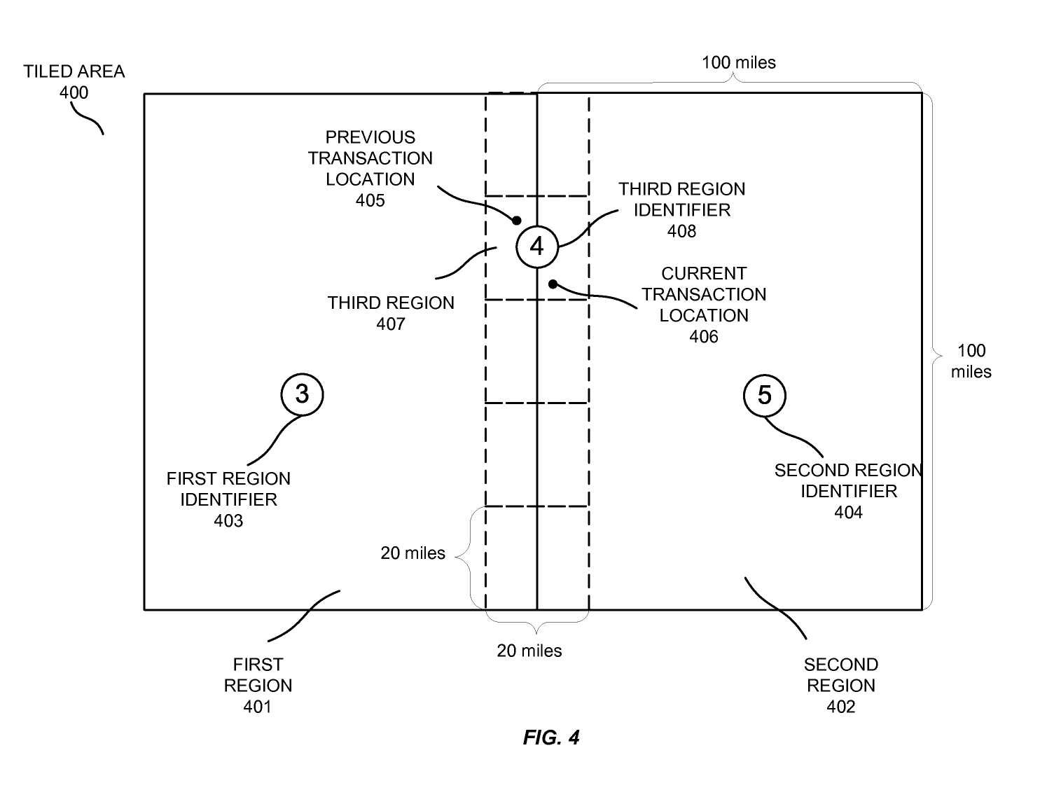

In some embodiments, an area may be partitioned by sets of regions having varying resolution in order to track a user's transaction history across regions of varying sizes. The multi-resolution regions may comprise multiple sets of regions, each set comprising regions of similar size. Utilization of regions of various sizes allows for a risk assessor to receive multiple sets of data, each set of data associated with a set of regions. This can allow pattern checking of location measurements to be carried out in different scales of region size. For example, location measurements gathered across a larger set of tiles may indicate the general movements of a user, while location measurements gathered across a smaller set of tiles may pinpoint purchase patterns at specific merchant types. Such an analysis can increase the possibilities for discovering a pattern amongst the user's transactions that can be utilized during risk analysis. FIG. 3 and FIG. 4 show examples of use cases of multi-resolution regions.

FIG. 3 is an exemplary image of a geographic region whose location may be obfuscated by use of concentric multi-resolution regions, according to some embodiments of the invention. FIG. 3 includes map 300, region 310, region 320, and region 330. The regions in this exemplary case are described as “tiles.” However, embodiments are not so limited and a region of any shape or size may be utilized. Further, any suitable number of regions may be arranged in a concentric manner as shown in FIG. 3. In some embodiments, the regions may not be concentric, but simply overlapping, where a smaller region may be completely surrounded by a larger region.

A user may have a consistent transaction pattern that is larger than the size of existing tiles, which may be more likely to generate spurious fraud alerts as a result. For example, using map 300 as an illustration of the San Francisco Bay Area region, a user may conduct some purchases within a region 330, but may also conduct transactions just outside of region 330 (e.g., within region 320). Since the risk assessor may not know that the regions of similar size around region 330 are simply adjacent to region 330 (because of the obfuscation), the relative infrequency of the purchases around tile 330 may trigger a fraud alert that is unwarranted. In other words, the relative infrequency of purchases around tile 330 may be acceptable because the user lives within tile 330, but the risk assessor does not possess this contextual information. Instead, the relative infrequency of purchases may improperly trigger a fraud alert.

To resolve this issue, in some embodiments, regions of multiple sizes may be simultaneously provided to the risk assessor. For example, the fraud detection system may track transactions within tiles of the sizes of regions 310, 320, and 330. In this way, the risk assessor may determine that a transaction occurring within a larger tile, while not occurring in a more frequented smaller tile, is still likely to be an acceptable transaction. Further to the previous example, if a purchase occurred in Oakland, Calif., but the user's most frequent purchases occur in San Leandro, Calif., then the purchase would fall outside of region 130, while still remaining within region 320. Since region 320 also includes the frequency of transactions within region 330, the risk assessor may determine that the purchase is within a sufficiently close enough geographic area to not be a suspicious transaction. The fraud detection system can know the relative sizes of the different regions (e.g., the order in size) and obtain each of the region identifiers for a particular transaction. In this manner, the fraud detection system can determine the relationship of the regions, without knowing where the regions actually are.

FIG. 4 is an exemplary location obfuscated by lining the boundary of one set of regions with another set of regions, according to some embodiments of the invention. FIG. 4 includes tiled area 400, first region 401, second region 402, first region identifier 403, second region identifier 404, previous transaction location 405, current transaction location 406, third region 407, and third region identifier 408. The lengths of the regions included in FIG. 4 are not drawn to relative scale. The regions in this exemplary case are described as “tiles.” However, embodiments are not so limited and a region of any shape or size may be utilized.

If only one set of disjoint tiles is used, measurements can occur arbitrarily close and still appear in separate regions. Since the regions are obfuscated (e.g., numbered randomly, which includes pseudo-randomly), there will be no information to the risk assessor that the measurements occurred close to each other. Accordingly, the risk assessor may be missing potentially important information in the risk scoring, which could lead to unjustified declines. To address this situation, the border of the tiles may be tiled with other smaller tiles, so that there is a good chance that measurements that occur near the border between two tiles will both occur inside a same smaller tile.

Having more than one set of regions would also allow different granularities, e.g. tiles with 100 mile edges, others with 20 mile edges, others with 1 mile edges, and yet others with 16 meter edges (typically the highest reliable resolution available with current technology). For example, area 400 is partitioned into tiles with 100 miles edges, including first region 401 and second region 402, and tiles with 20 mile edges, including third region 407. The tiles can be arranged such that the 20 mile tiles span the borders of the 100 mile edges.

The risk assessor may receive multiple sets of information based on previous transaction location 405 and current transaction location 406. Previous transaction location 405 is located in 100 mile edge first region 401 and 20 mile edge third region 407, while current transaction location 406 is located in 100 miles edge second region 402 and 20 mile edge region 407. The risk assessor would receive the multiple sets of data only by reference to region identifiers, where first region 401 is associated with first region identifier 403, second region 402 is associated with second region identifier 404, and third region 407 is associated with third region identifier 408. For example, risk assessor may receive information that previous transaction location 405 is located in region “3” and region “4,” while current transaction location 406 is located in region “5” and region “4.” Hence, each measurement of a mobile phone would name one 100 mile tile and one 20 mile tile together with a point in time. This makes it likely that if two measurements are in different 100 mile tiles but within less than 20 miles that they will be associated with a common tile. The resolution of a region can be part of a region identifier, and thus the number may be the same, but the resolution can differ.

Utilizing tiles of various sizes for location obfuscation as described above provides useful information since the risk assessor may be able to identify relationships between tiles based on received region identifiers. In the example shown in FIG. 4, each transaction is associated with multiple region identifiers. Hence, the risk assessor may note that region “3” and region “4” associated with the previous transaction are overlapping regions, and region “4” and region “5” associated with the current transaction are also overlapping regions. Accordingly, the risk assessor may check for and take into account similar patterns between region “3” and region “5” based on statistical values when calculating the classification of fraud for the current transaction.

Accordingly, in the example shown in FIG. 4, smaller tile sets may be utilized to line boundaries of larger regions. For example, lining a boundary of a 100 mile edge region with 1 mile edge regions can ensure that transaction locations that are very close to each other, such as less than a 1 mile from each other, may share a common tile. This can help prevent the risk assessor from interpreting two relatively close transactions to be associated with two different region identifiers, where the region identifiers do not have any relation to each other (i.e., the risk assessor sees them as separate and potentially remote regions).

In some embodiments, the use cases relating to regions of various sizes described in FIG. 3 and FIG. 4 may be combined. For example, an area may be partitioned to include concentric tiles of different sizes and smaller bordering tiles, which may increase possibilities for pattern checking carried out based on transaction data. Further, while FIG. 4 shows only one boundary between disjoint tiles covered with smaller tiles for simplicity, embodiments allow any number of boundaries to be covered with regions of any size or shape.

In some embodiments, regions of different resolution may have the same region identifier. However, such regions may be distinctly identified by their resolution. For example, a region from a set of large regions may be correspond to a first region identifier “6,” and a region from a set of small regions may correspond to a second region identifier “6.” Since the fraud detection system can know the relative sizes (resolution) of the different regions, the fraud detection system can differentiate the small region from the set of large regions and the large region from the set of small regions, despite their matching region identifiers.

With some or all of the above mechanisms in place for receiving a transaction at a certain time and a certain location (by region identifier), it can be checked whether the transaction follows certain established patterns, in particular if the location is within tiles with a history of visits and purchases by the user. The more the transaction falls within existing patterns, the lower location-based risk should be assigned to it. This location-based analysis can be used to determine the overall risk score and help inform the risk assessor's approval decision.

C. Method

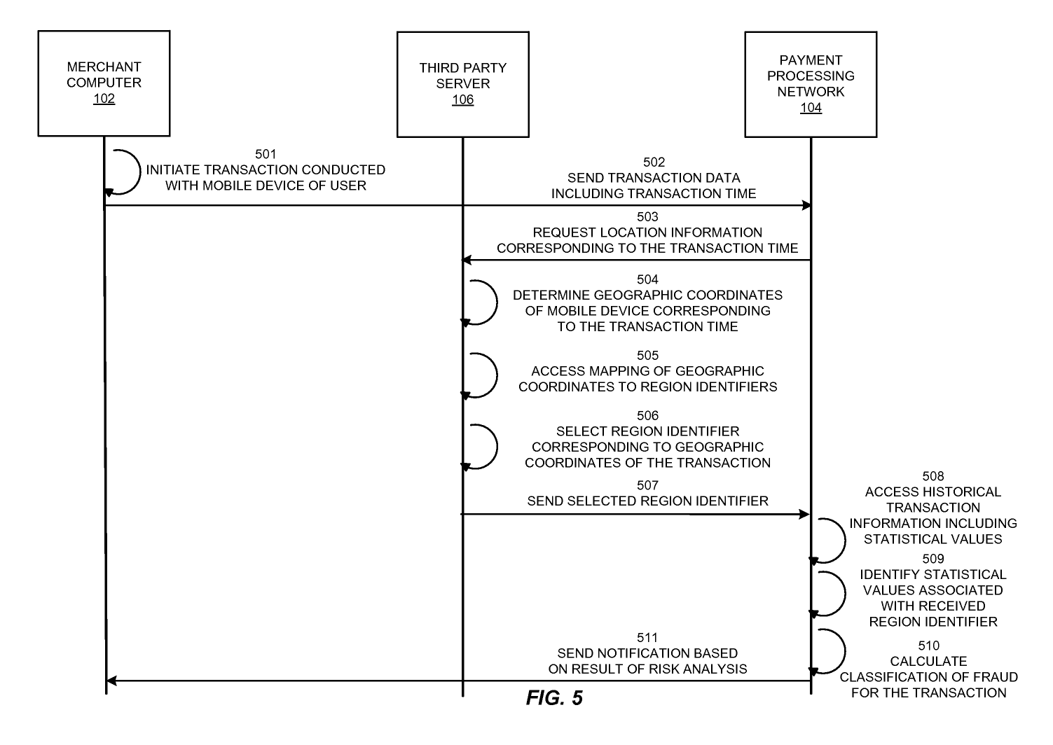

FIG. 5 is an exemplary process flow, according to some embodiments of the invention. FIG. 5 shows data that can be communicated amongst merchant computer 102, third party server 106, and payment processing network 104. Any of these entities may communicate over a suitable communication network.

At step 501, merchant computer 102 initiates a transaction with a user. In some embodiments, the transaction can be by cash, debit card, credit card, and other mechanisms separate form a mobile device (e.g., a phone). In other embodiments, the transaction may involve the user utilizing a mobile device. For example, the user may use a mobile application, such as a payment or wallet application, at the time of purchase. The user's mobile device may enable any suitable wireless or short-range communication technology (e.g., NFC, BLE, etc.) that allows it to communicate with an access device at merchant computer 102. Regardless of how the transaction was initiated, the user's mobile device can be used to determine a location of the user at a time of the transaction.

At step 502, merchant computer 102 sends transaction data, including transaction time, to payment processing network 104 (e.g., acting as or including a fraud detection system). The transaction data may include any information regarding the transaction made by the user at merchant computer 102. The transaction data may include the timestamp of the transaction so that payment processing network 104 can request location data based on time.

At step 503, payment processing network 104 requests, from third party server 106, location information of the user's mobile device corresponding to the time of the transaction. The request may be for obfuscated location information, which is determined by third party server 106. In some embodiments, the request can be made in real-time when the transaction data is received. In other embodiments, the request can be made at a scheduled time, e.g., as part of batch processing that may occur at the end of the day or other time period.

At step 504, third party server 106 determines geographic coordinates of the user's mobile device corresponding to the transaction time. Geographic coordinates indicate a geographic location on Earth. Third party server 106 may conduct a location measurement in real-time. The payment processing network 104 may send a request to third party server 106 for location information shortly after receiving notification that a transaction was conducted by the user's mobile device. Subsequently, third party server 106 may query the user's mobile device for current location data and thus determine relevant geographic coordinates corresponding to the transaction time.

In some embodiments, third party server 106 may retrieve a location measurement from previously stored location information. Third party server 106 may track location data of the user's mobile device in regular intervals by querying and storing location data from the user's mobile device at certain time intervals. In order to determine geographic coordinates of the user's mobile device corresponding to the transaction time, third party server 106 may search through collected location data and find location data that was tracked at a time close to the transaction time. Third party server 106 may simply select geographical coordinates associated with the location closest to the transaction time, or may execute an algorithm to interpolate a location between two locations tracked at certain times.

At step 505, third party server 106 accesses a mapping of geographic coordinates to region identifiers of geographic regions, each geographical region having an assigned region identifier. Each geographic region is associated with a region identifier, which may be of any type (e.g., numeric, alphanumeric, etc.) and uniquely identify the geographic region. Each geographic region may correspond to a range of geographical coordinates residing within the boundaries of the geographic region. In some embodiments, certain geographical coordinates may lie in more than one geographic region associated with a region identifier, e.g., when using sets of regions that are different resolution or are overlapping. In one aspect, the actual location of a geographic region cannot be derived from the region identifier alone. However, the mapping between geographic coordinates to region identifiers may be refreshed periodically to further prevent potential deduction of actual location based on patterns over time.

At step 506, third party server 106 selects a region identifier corresponding to geographic coordinates of the transaction. Third party server 106 may search for and determine any geographic regions containing the geographic coordinates of the transaction. Third party server 106 may then select the one or more region identifiers associated with the one or more determined geographic regions. In some embodiments, regions may overlap, which may result in certain geographic coordinates corresponding to multiple region identifiers. In this case, third party server 106 may select and send all corresponding region identifiers.

At step 507, third party server 106 sends the selected region identifier to payment processing network 106. Since actual location information is obfuscated by use of region identifiers, payment processing network 104 cannot infer the actual geographic location of the transaction. However, the received region identifier may be useful in view of region identifiers associated with historical transactions of the user.

At step 508, payment processing network 104 accesses historical transaction information, including statistical values associated with a plurality of region identifiers, from a database. Payment processing network 104 may store historical transaction information based on region identifiers in a database. For example, historical transaction information may indicate the frequency of transactions over a time period that occurred in each geographic region corresponding to a region identifier. The historical transaction information may comprise statistical values calculated from transaction data associated with region identifiers.

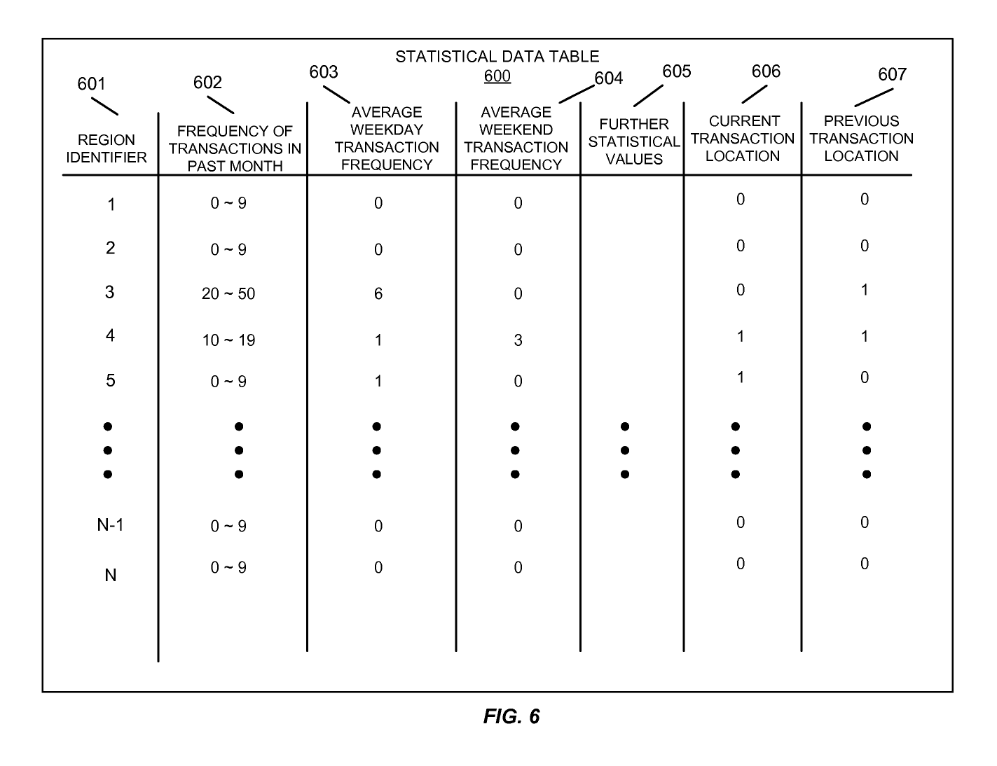

At step 509, payment processing network 104 identifies statistical values associated with the region identifier received from third party server 106. The statistical values may be stored in the database organized by the region identifier, which may include a resolution level. Payment processing network 104 may identify multiple statistical values associated with the received region identifier. In some embodiments, statistical values may be calculated over various time periods, such as over certain recurring days, time of day, or time of year. Further examples of statistical values are described in more detail with respect to FIG. 6.

At step 510, payment processing network 104 calculates a classification of fraud for the user's transaction based on the identified statistical values associated with the received region identifier. The statistical values can be utilized to calculate a fraud level of the transaction in a variety of ways. For example, statistical values may indicate that the user has carried out transactions very frequently in the geographical region associated with the received region identifier during the past month. This can be an indication that the current transaction being analyzed follows a known pattern and therefore presents low risk. In some embodiments, the fraud level may be calculated by any suitable algorithm utilizing statistical values corresponding to region identifiers as inputs. For example, the statistical values can be fed into a decision tree, a neural network, or other model. The calculated fraud level may correspond to a certain classification of fraud (e.g., low risk, moderate risk, high risk).

At step 511, payment processing network 104 may send a notification to merchant computer 102 based on calculated classification of fraud. Depending on the classification of fraud determined by risk analysis, payment processing network 104 may choose to approve or reject the transaction. If the risk analysis is carried out in real-time at the time of purchase, payment processing network 104 may send a notification to the access device of merchant computer 102 indicating the result of the risk analysis. For example, if the determined fraud level exceeds a certain threshold value, the transaction may be deemed high risk and consequently, an alert or notification indicating high risk may be sent to merchant computer 102.

In other embodiments, if risk analysis is carried out in batch after the time of purchase (i.e., at settlement) and the determined classification of fraud exceeds a certain threshold, payment processing network 104 may choose to contact the user of the mobile device to help determine whether fraudulent activity occurred. In some instances, the fraud detection system may not authorize the transaction if the fraud level exceeds a certain threshold (e.g., fraud score corresponding to high risk).

### III. Risk Analysis Based on Obfuscated Location Information

A. Statistical Analysis of Historical Transaction Information

In some embodiments, the fraud detection system (risk assessor) may aggregate a summary, including statistical values, of historical transaction information. Analyzing a transaction based on its associated region identifier and statistical values associated with historical transaction information can still allow for location-based risk analysis without utilizing actual geographic location information. The fraud detection system can utilize summaries of statistical values and act upon whether certain transactions follow a usual or unusual pattern. In some implementations, the third party server may send a summary including statistical values of historical transaction information to the fraud detection system, which may prevent correlating obfuscated location data to actual locations that users are located. Statistical values may be presented to the fraud detection system in various ways as shown in FIG. 6.

FIG. 6 is exemplary statistical information that may be utilized by the fraud detection system, according to embodiments of the invention. An exemplary statistical data table 600 may include various fields including region identifier 601, frequency of transactions in the past month 602, average frequency of transactions on weekdays 603, average frequency of transactions on weekends 604, further statistical values 605, location of current transaction 606, and location of previous transaction 607. Exemplary fields are described herein, but embodiments are not so limited. Any suitable statistical values that may assist or be utilized for risk analysis may be included in statistical data table 600. Hence, each region identifier may be associated with a plurality of statistical values.

Historical transaction information may be utilized for risk analysis. The historical transaction information may be recent, e.g., within a specified time window of the current time. For example, the statistical data table 600 may comprise frequency of transactions in the past month 602 to display any recent patterns of transactions occurring in certain regions. For example, statistical data table 600 may indicate the region associated with region identifier “3” as having the most transactions in the past month. This may serve to show that transactions occurring in recently frequented tiles may be of low risk.

In some embodiments, a frequency of transactions may be displayed in bands or ranges, such as “20˜50,” indicating between 20 and 50 transactions. In other embodiments, frequency may be displayed in categories corresponding to risk levels, such as “very frequently,” “frequently,” “moderately,” or “rarely,” with each level mapping to a range of frequencies of transactions. These generalized values, such as banded frequencies or named categories, substituting for actual frequency counts may assist in preventing the fraud detection system (risk assessor) from determining actual locations associated with region identifiers based on patterns over time. These generalized values can be sufficient for the risk assessor to identify patterns amongst transaction locations based on region identifiers.

Another example of how historical transaction information may be analyzed is over recurring time periods. For instance, average historical transaction frequencies may be gathered over certain days, such as average frequency of transactions on weekdays 603 and average frequency of transactions on weekends 604. This may help the risk assessor determine any existing temporal patterns in the user's transactions. Such patterns may be useful since the risk assessor can check whether the current transaction being analyzed can fit into any of the known patterns. In an exemplary case, the user may conduct many or most transactions in a first region near the workplace on weekdays and many or most transactions in a second region near home on weekends. For example, if the current transaction being analyzed took place on a weekend, the risk assessor may analyze the statistical value for the weekend activity associated with the received region identifier. If a pattern match can be found, the current transaction may be determined to be of lower risk. The analysis can also use statistical values of other region identifier, e.g., when normalization is performed.

Further, statistical data table 600 may also contain location information specific to certain transactions. This information may be useful to isolate certain transactions and analyze them against each other or against historical transaction information. For example, statistical data table 600 may comprise location of current transaction 606 and location of previous transaction 607. Comparing the location information of these two transactions may be relevant given their known transaction times. If current transaction 606 and previous transaction 607 are identified to have occurred within minutes of each other, the transactions would be expected to occur in the same general area. However, if region identifiers corresponding to the two transactions received from the third party server do not indicate any common region identifiers (e.g., even for large regions) or do not fit any usual pattern indicated by historical transactions, the current transaction 606 being analyzed may present a potential risk of fraudulent activity. The risk assessor may be able to infer that the current transaction 606 and previous transaction 607 may have occurred in unrelated regions, even though it would not be possible to travel between two regions of a certain size (resolution) within minutes.

The blank column for further statistical values 605 indicates that any other statistical values based on historical transactions may be included in data table 600. While the example data fields demonstrate analysis over recurring time periods across multiple days, embodiments are not so restricting. Analysis may be taken over longer periods of times, such as weeks, months, seasons, as well as over shorter periods of times, such as mornings, afternoons, and evenings. Statistical values may be calculated over a finite time period (e.g., average over 3 months) or over recurring time periods (e.g., average over every Sunday morning). After receiving region identifiers associated with a transaction and statistical values associated with historical transactions, the risk assessor has the choice to customize the types of statistical values and algorithms it will utilize to carry out risk analysis.

Further, statistical values of historical location information may be stored in other ways other than shown in FIG. 6. One example may be a multiple resolution grid, in which one grid may store a counter of the frequency of transactions that occurred within a certain time period. For example, there could be a whole set of counters associated with a particular region identifier, each counter associated with a different time period (e.g., 7 day period, 30 day period, 60 day period). Another example may be a multi-dimensional grid with region identifiers on one axis and time periods along another axis. Each cell in the grid could correspond to a counter of the frequency of transactions that occurred during the specified time period. For example, a cell may indicate that the user has been in the region corresponding to region identifier “3” on seven occasions on Sunday mornings. The risk assessor can have the choice to customize the way statistical values to be utilized in risk analysis are presented.

Historical transaction information stored by the risk assessor may periodically be updated. One reason why historical transaction information may be updated is that the risk assessor may receive updated assignments of regions identifiers to geographical regions. This may occur every time the third party server updates the mapping of region identifiers to geographical regions. Subsequently, the statistical values associated with region identifiers may be updated. Statistical values may be changed to be associated with the updated region identifiers of geographical regions. This can make it more difficult for the risk assessor to deduce certain location information based on patterns associated with region identifiers and thus further obfuscate location information.

Another reason why historical transaction information may be updated is to include newly validated transactions into statistical values stored by the risk assessor. As new transactions are validated, they may not necessarily be included into statistical values of historical transaction information immediately. This may ensure that any transaction that may be determined to be fraudulent at a later time is not included immediately into historical data statistics, which may skew risk analysis. Further, not opting to include one transaction into historical transaction information for a time period is not expected to affect historical transaction patterns significantly, as users most likely will not change their lifestyle patterns often. While a significant change may occur occasionally, such as the user moving to a new workplace or home, it would take some time for a new pattern to be reflected in statistical analysis of historical transaction information. Hence, while the risk assessor stores and maintains summaries of statistical values associated with historical transaction data, the risk assessor may also store raw obfuscated location data received from the third party server for a time period (e.g., one week) before including the raw data into the summaries of statistical values.

B. Classification of Fraud

Risk analysis based on obfuscated location information can help determine a classification of fraud associated with a particular transaction. A classification of fraud may comprise a numerical fraud score associated with a transaction. A numerical fraud score corresponding to the transaction may be the calculated result of risk analysis utilizing information associated with the transaction.

If the determined classification of fraud exceeds a threshold value, action may be taken by the risk assessor. For example, the risk assessor may send a notification in real-time informing the merchant of a fraud level calculated for the transaction. The merchant may receive the notification and then decide whether or not to continue with the transaction. In some embodiments, the risk assessor may determine that the risk level is very high based on comparing the classification of fraud of the transaction (e.g., numerical fraud score of the transaction) to a threshold value (e.g., numerical fraud score corresponding to high risk). If the classification of fraud exceeds the threshold value, the fraud detection system may send an alert to the merchant. Additionally, this may prompt the risk assessor to not authorize the transaction. Other actions may also be taken based on various threshold values set by the risk assessor.

C. Risk Analysis Examples

The following may cover some examples of how risk analysis utilizing obfuscated locations may be carried out, according to embodiments of the invention. The examples may be described in reference to FIG. 3.

In an embodiment, risk analysis may be carried out by doing a risk assessment based on frequency associated with the region that the current transaction occurred. For example, if the current transaction being analyzed occurred in region 330, the risk assessor may check a frequency counter associated with region 330. If the user recently conducted frequent transactions in region 330, the risk assessor may take this information into account and deduce the current transaction is of low risk.

Different sets of analyses may be carried out based on multiple sets of regions, each set corresponding to a region size. This is beneficial as a pattern that may not be discovered based on analysis of a set of smaller regions may be discoverable based on analysis of a set of larger regions or vice versa. On the other hand, in some embodiments, similar patterns may exist between transactions in regions of one size versus transactions in regions of another size. The fraud detection system may utilize such information about patterns when carrying out risk analysis of transactions.

Risk analysis for a transaction may be carried out by combining a plurality of risk analysis results, each result corresponding to a separate region. A certain weight may be applied to each of the risk analysis results, where each result may comprise a numerical value based on statistical values. For example, a current transaction may be initially analyzed for risk based on the set of regions corresponding to the size of region 330. This may result in the current transaction being deemed a classification of “moderate risk,” which may correspond to a certain numerical fraud score. Since the risk assessor may determine that this risk analysis alone does not provide enough information to deduce that that the current transaction is not likely to be fraudulent, a subsequent risk analysis may be carried out based on another set of regions corresponding to the size of region 320. If the second risk analysis returns a low risk level, the risk assessor may decide that the current transaction is not fraudulent. In some embodiments, a risk analysis may be carried out for multiple sets of regions corresponding to various sizes, where each set of regions may have a different impact on the overall classification of fraud calculated. For example, each larger set of regions may apply a lower impact or weight to the overall classification of fraud when aggregated into a combined fraud score. The risk assessor may determine how to weight results from different sets according to various criteria, e.g., based on size of the regions.

In some embodiments, time and merchant type can be utilized as a factor in determining patterns amongst sets of location data. For example, a user may always visit a coffee shop at similar days of the week or similar times of the day (e.g., Monday mornings). The risk assessor may determine that although transactions corresponding to these coffee shop visits occurred in different regions, they are not that high risk since the type of purchase is consistent with a known timely pattern. Another example is that the user may purchase gas at different gas stations around the same time intervals (e.g., every 10 days etc.) While the transactions may not necessarily all occur in the same region, the risk assessor may have reason to determine these transactions as low risk since they fit a pattern based on merchant type and time.

### IV. Computer System

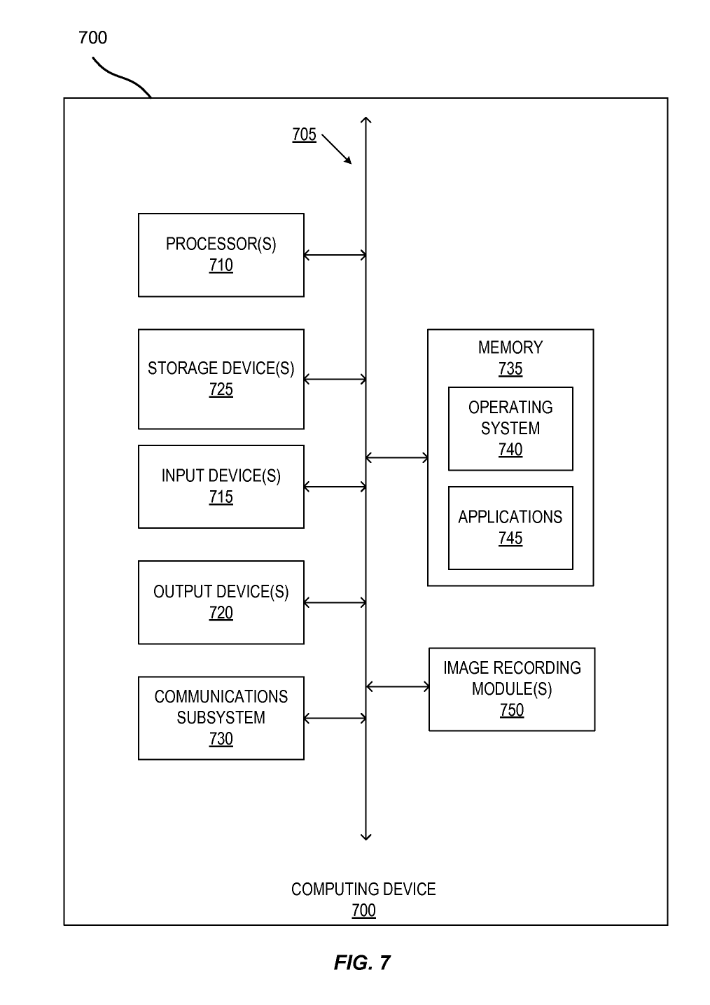

Having described multiple aspects of performing location based risk scoring using obfuscated locations, an example of a computing system in which various aspects of the disclosure may be implemented will now be described with respect to FIG. 7. According to one or more aspects, a computer system as illustrated in FIG. 7 may be incorporated as part of a computing device, which may implement, perform, and/or execute any and/or all of the features, methods, and/or method steps described herein. For example, computer system 700 may represent some of the components of a hand-held device. A hand-held device may be any computing device with an input sensory unit, such as a wireless receiver or modem. Examples of a hand-held device include but are not limited to video game consoles, tablets, smart phones, televisions, and mobile devices or mobile stations. In other examples, computer system 700 may represent some of the components of a system housed within a base vehicle platform. In some embodiments, the system 700 is configured to implement any of the methods described above. FIG. 7 provides a schematic illustration of one embodiment of a computer system 700 that can perform the methods provided by various other embodiments, as described herein, and/or can function as the host computer system, a remote kiosk/terminal, a point-of-sale device, a mobile device, a set-top box, and/or a computer system. FIG. 7 is meant only to provide a generalized illustration of various components, any and/or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a camera, wireless receivers, wireless sensors, wired sensors, a mouse, a keyboard and/or the like; and one or more output devices 720, which can include without limitation a display unit, a printer and/or the like. In some embodiments, the one or more processor 710 may be configured to perform a subset or all of the functions described above with respect to FIGS. 1 to 7. The processor 710 may comprise a general processor and/or and application processor, for example. In some embodiments, the processor is integrated into an element that processes visual tracking device inputs and wireless sensor inputs.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 730, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above. Also, image recording module(s) 750 may be included to record images. In other cases, input device(s) 715 may receive the image data, and output device(s) 720 may transmit the image data to other devices.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 1 to 7, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein, for example methods described with respect to FIGS. 1 to 6.

The terms “machine-readable medium,” “computer-readable medium,” and “computer program product,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire and fiber optics, including the wires that comprise the bus 705, as well as the various components of the communications subsystem 730 (and/or the media by which the communications subsystem 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710. Memory 735 may contain at least one database according to any of the databases methods described herein. Memory 735 may thus store any of the values discussed in any of the present disclosures.

The methods described in FIGS. 1 to 6 may be implemented by various blocks in FIG. 7. For example, processor 710 may be configured to perform any of the functions of blocks in diagram 700. Storage device 725 may be configured to store an intermediate result, such as a globally unique attribute or locally unique attribute discussed within any of blocks mentioned herein. Storage device 725 may also contain a database consistent with any of the present disclosures. The memory 735 may similarly be configured to record signals, representation of signals, or database values necessary to perform any of the functions described in any of the blocks mentioned herein. Results that may need to be stored in a temporary or volatile memory, such as RAM, may also be included in memory 735, and may include any intermediate result similar to what may be stored in storage device 725. Input device 715 may be configured to receive wireless signals from satellites and/or base stations according to the present disclosures described herein. Output device 720 may be configured to display images, print text, transmit signals and/or output other data according to any of the present disclosures.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method comprising:
receiving, at a fraud detection system, transaction data for a first transaction by a user, the transaction data including a first time of the first transaction;
receiving, at the fraud detection system from a third party server, a first region identifier that corresponds to a first geographical region in which the first transaction occurred at the first time, wherein the third party server is configured to:
store a mapping of geographical coordinates to region identifiers of geographical regions, each geographical region having an assigned region identifier;
determine first geographical coordinates of the user at the first time based on a location of a mobile device of the user; and
select the first region identifier from the region identifiers using the first geographical coordinates, the first region identifier obfuscating the first geographical coordinates from the fraud detection system;
accessing, by the fraud detection system, historical transaction information of the user from a database, the historical transaction information including one or more statistical values associated with each of a plurality of the region identifiers of geographical regions, each of the statistical values conveying an amount of transactions by the user within a specified time period for the geographical region corresponding to the region identifier associated with the statistical value;
identifying, by the fraud detection system, the one or more statistical values associated with the first region identifier received from the third party server; and
calculating, by the fraud detection system, a classification of fraud for the first transaction based on the one or more identified statistical values corresponding to the first region identifier.

2. The method of claim 1, further comprising:
not authorizing the first transaction if the classification of fraud for the first transaction exceeds a threshold.

3. The method of claim 1, further comprising:
sending an alert if the classification of fraud for the first transaction exceeds a threshold.

4. The method of claim 1, wherein a first set of the geographic regions are of a first size and a second set of the geographic regions are of a second size that is larger than the first size.

5. The method of claim 4, wherein at least a portion of the geographic regions of the first set overlap with two geographic regions of the second set.

6. The method of claim 5, wherein the first geographical region is of the second set, the method further comprising:
receiving, at the fraud detection system from the third party server, a second region identifier that corresponds to a second geographical region of the first set in which the first transaction occurred at the first time;
identifying that the second geographic region overlaps with the first geographical region and with a third geographical region of the second set, a third region identifier assigned to the third geographical region;
calculating, by the fraud detection system, the classification of fraud for the first transaction based further on the one or more identified statistical values corresponding to the third region identifier.

7. The method of claim 4, wherein the first geographical region is of the first set, the method further comprising:
receiving, at the fraud detection system from the third party server, a second region identifier that corresponds to a second geographical region of the second set in which the first transaction occurred at the first time;
identifying, by the fraud detection system, the one or more statistical values associated with the second region identifier received from the third party server; and
calculating, by the fraud detection system, the classification of fraud for the first transaction based further on the one or more identified statistical values corresponding to the second region identifier.

8. The method of claim 7, wherein calculating the classification of fraud for the first transaction based on the one or more identified statistical values corresponding to the first and second region identifiers includes:
calculating a first classification based on the one or more identified statistical values corresponding to the first identifier;
calculating a second classification based on the one or more identified statistical values corresponding to the second region identifier;
computing the classification of fraud as a combination of the first classification and the second classification, wherein the second classification is weighted less the first classification as a result of the second geographical region being larger than the first geographical region.

9. The method of claim 1, wherein the region identifiers are assigned randomly to the geographical regions.

10. The method of claim 1 further comprising:
periodically receiving an update of assignments of region identifiers to the geographical regions; and
changing the statistical values to be associated with the updated region identifiers of geographical regions.

11. The method of claim 1, wherein the classification of fraud comprises a numerical fraud score.

12. A fraud detection system comprising:
one or more processors;
a database storing historical transaction information including one or more statistical values associated with each of a plurality of region identifiers of geographical regions, each of the statistical values conveying an amount of transactions by a user within a specified time period for a geographical region corresponding to a region identifier associated with the statistical value; and
a non-transitory computer-readable storage medium comprising code executable by the one or more processors for implementing a method comprising:
receiving transaction data for a first transaction by the user, the transaction data including a first time of the first transaction;
receiving, from a third party server, a first region identifier that corresponds to a first geographical region in which the first transaction occurred at the first time, wherein the third party server is configured to:
store a mapping of geographical coordinates to region identifiers of geographical regions, each geographical region having an assigned region identifier;
determine first geographical coordinates of the user at the first time based on a location of a mobile device of the user; and
select the first region identifier from the region identifiers using the first geographical coordinates, the first region identifier obfuscating the first geographical coordinates;
accessing historical transaction information of the user from the database;
identifying the one or more statistical values associated with the first region identifier received from the third party server; and
calculating a classification of fraud for the first transaction based on the one or more identified statistical values corresponding to the first region identifier.

13. The fraud detection system of claim 12, wherein a first set of the geographic regions are of a first size and a second set of the geographic regions are of a second size that is larger than the first size.

14. The fraud detection system of claim 13, wherein the first geographical region is of the second set, the method further comprising:
receiving, from the third party server, a second region identifier that corresponds to a second geographical region of the first set in which the first transaction occurred at the first time;
identifying that the second geographic region overlaps with the first geographical region and with a third geographical region of the second set, a third region identifier assigned to the third geographical region;
calculating the classification of fraud for the first transaction based further on the one or more identified statistical values corresponding to the third region identifier.

15. The fraud detection system of claim 13, wherein the first geographical region is of the first set, the method further comprising:
receiving, from the third party server, a second region identifier that corresponds to a second geographical region of the second set in which the first transaction occurred at the first time;
identifying the one or more statistical values associated with the second region identifier received from the third party server; and
calculating the classification of fraud for the first transaction based further on the one or more identified statistical values corresponding to the second region identifier.

16. The fraud detection system of claim 15, wherein calculating the classification of fraud for the first transaction based on the one or more identified statistical values corresponding to the first and second region identifiers further includes:
calculating a first classification based on the one or more identified statistical values corresponding to the first identifier;
calculating a second classification based on the one or more identified statistical values corresponding to the second region identifier;
computing the classification of fraud as a combination of the first classification and the second classification, wherein the second classification is weighted less the first classification as a result of the second geographical region being larger than the first geographical region.

17. The fraud detection system of claim 12, the method further comprising:
periodically receiving, from the third party server, an update of assignments of region identifiers to the geographical regions; and
changing the statistical values to be associated with the updated region identifiers of geographical regions.

18. A third party server comprising:
one or more processors;
a database storing a mapping of geographical coordinates to region identifiers of geographical regions, each geographical region having an assigned region identifier; and
a non-transitory computer-readable storage medium comprising code executable by the one or more processors for implementing a method comprising:
receiving a request from a fraud detection system, the request indicating a first time corresponding to a first transaction;
determining first geographical coordinates of a user at the first time based on a location of a mobile device of the user; and
selecting a first region identifier from the region identifiers using the first geographical coordinates, the first region identifier corresponding to a first geographical region that includes the first geographical coordinates; and
sending the first region to the fraud detection system, wherein the first region identifier obfuscates the first geographical coordinates from the fraud detection system.

19. The third party server of claim 18, wherein the region identifiers are assigned randomly to the geographical regions.

20. The third party server of claim 18, wherein the method further comprises:
periodically sending, to the fraud detection system, an update of assignments of region identifiers to the geographical regions.
